(19) United States
(12) Patent Application Publication
(10) Pub. No.: US 2026/0063305 A1
(43) Pub. Date: Mar. 5, 2026

(54) WHITE CERAMIC GLASS, METHOD FOR MANUFACTURING WHITE CERAMIC GLASS, AND COOKTOP INCLUDING WHITE CERAMIC GLASS

(71) Applicant: SAMSUNG ELECTRONICS CO., LTD., Suwon-si (KR)

(72) Inventors: Jiyoung SONG, Suwon-si (KR); Jooyong Yoon, Suwon-si (KR); Kwangjoo Kim, Suwon-si (KR)

(73) Assignee: SAMSUNG ELECTRONICS CO., LTD., Suwon-si (KR)

(21) Appl. No.: 19/216,345

(22) Filed: May 22, 2025

Related U.S. Application Data
(63) Continuation of application No. PCT/KR2025/005781, filed on Apr. 29, 2025.

(30) Foreign Application Priority Data
Sep. 5, 2024 (KR) 10-2024-0121195
Sep. 27, 2024 (KR) 10-2024-0132044

(51) Int. Cl. F24C 15/10; C03C 4/02; C03C 15/02

(52) U.S. Cl. CPC F24C 15/102; C03C 4/02; C03C 15/02; C03C 2204/08

(57) ABSTRACT

A cooktop may include: a cooktop body; and a white ceramic glass on an upper portion of the cooktop body, the white ceramic glass including: a plurality of micro recesses with an average depth of the plurality of micro recesses being 30 μm or less, and a plurality of embossed portions with an average width of the plurality of embossed portions being 80 μm to 130 μm, wherein each embossed portion of the plurality of embossed portions protrudes upward between two or more micro recesses of the plurality of micro recesses.

### CROSS-REFERENCE TO RELATED APPLICATIONS

This application is a continuation application, claiming priority under § 365(c), of an International application No. PCT/KR2025/005781, filed on Apr. 29, 2025, which is based on and claims the benefit of a Korean patent application number 10-2024-0121195, filed on Sep. 5, 2024, in the Korean Intellectual Property Office, and of a Korean patent application number 10-2024-0132044, filed on Sep. 27, 2024, in the Korean Intellectual Property Office, the disclosure of each of which is incorporated by reference herein in its entirety.

### TECHNICAL FIELD

Various embodiments of the disclosure relate to a white ceramic glass, a method for manufacturing a white ceramic glass, and a cooktop including a white ceramic glass and, specifically, to a white ceramic glass with enhanced cleaning efficiency (or ease of cleaning) and scratch resistance, and a cooktop including the same.

### BACKGROUND ART

An induction device (or induction heating device) may be used as a heat source to generate heat. In particular, a cooktop (or hob) may be used as a cooking device for heating food by means of an induction device.

The upper portion of the cooktop may be formed of a ceramic glass with excellent heat resistance. The ceramic glass has the advantages of being nearly immune to thermal shock fractures and having excellent mechanical strength and thermal conductivity.

Ceramic glasses may be divided into white, black, or transparent ceramic glasses depending on the color. Each ceramic glass should have a certain level of scratch resistance and cleaning efficiency. Due to a different composition or crystal size from that of the black ceramic glass or transparent ceramic glass, the white ceramic glass may reduce in scratch resistance or cleaning efficiency when manufactured by the same process as the black ceramic glass or transparent ceramic glass.

Research is ongoing to manufacture white ceramic glasses with excellent performance.

The above-described information may be provided as related art for the purpose of helping understanding of the disclosure. No claim or determination is made as to whether any of the foregoing is applicable as background art in relation to the disclosure.

### DISCLOSURE OF INVENTION

### Solution to Problems

In accordance with the present disclosure, a cooktop may include: a cooktop body; and a white ceramic glass on an upper portion of the cooktop body, the white ceramic glass including: a plurality of micro recesses with an average depth of the plurality of micro recesses being 30 μm or less, and a plurality of embossed portions with an average width of the plurality of embossed portions being 80 μm to 130 μm, wherein each embossed portion of the plurality of embossed portions protrudes upward between two or more micro recesses of the plurality of micro recesses.

A surface roughness of the white ceramic glass may be 1.5 μm to 2.5 μm.

An average width of the plurality of micro recesses may be 100 μm or more.

An upper surface of the white ceramic glass may be coated with a coating material.

The white ceramic glass may include a beta-spodumene crystal structure.

A diameter of a crystal of the white ceramic glass may be 0.9 μm to 1.1 μm.

The plurality of micro recesses may be in a surface of the white ceramic glass, the surface being an elastomer particle blasted, etched, and polished surface.

The white ceramic glass may be a chemically reinforced white ceramic glass.

The cooktop may further include: a display device, wherein the white ceramic glass may include a through hole corresponding to the display device so that the display device displays information through the through hole.

The white ceramic glass may include an edge reinforcement area along an edge of the through hole, the edge reinforcement area may have a depth of 100 μm or less from a surface of the edge.

The elastomer particle may include a silicon elastomer coated on at least one of aluminum oxide (Al2O3), silicon carbide (SiC), cerium oxide (CeO2), silicon dioxide (SiO2), chromium dioxide (CrO2), lanthanum oxide (La2O3), boron carbide (B4C), or zirconium oxide (ZrO2).

The white ceramic glass may include a chemically reinforced area that may have a depth of 100 μm or less from a surface of the white ceramic glass.

In accordance with the present disclosure, a method for manufacturing a white ceramic glass may include: blasting elastomer particles onto a surface of the white ceramic glass to form a blasted surface of the white ceramic glass; exposing the blasted surface to a hydrofluoric acid (HF) solution to form an etched surface of the white ceramic glass; and polishing the etched surface to form a polished surface until the polished surface includes: a plurality of micro recesses with an average depth of the plurality of micro recesses being 30 μm or less, a plurality of embossed portions with an average width of the plurality of embossed portions being 80 μm to 130 μm, each embossed portion of the plurality of embossed portions protrudes upward between two or more micro recesses of the plurality of micro recesses, and a surface roughness of the polished surface is 1.5 μm to 2.5 μm.

The method may further include: before the blasting, perforating an area of the white ceramic glass.

The method may further include: chemically reinforcing the polished surface of white ceramic glass.

In accordance with the present disclosure, a white ceramic glass may include: an upper surface including: a plurality of micro recesses with an average depth of the plurality of micro recesses being 30 μm or less; and a plurality of embossed portions with an average width of the plurality of embossed portions being 80 μm to 130 μm, wherein each embossed portion of the plurality of embossed portions protrudes upward from the upper surface between two or more micro recesses of the plurality of micro recesses, and a surface roughness of the upper surface may be 1.5 μm to 2.5 μm.

A crystal structure of the white ceramic glass may include a beta-spodumene crystal structure, and a diameter of a crystal in the crystal structure may be 0.9 μm to 1.1 μm.

The white ceramic glass may further include: a through hole through the white ceramic glass; and an edge reinforcement area along an edge of the through hole, the edge reinforcement area may have a depth of 100 μm or less from a surface of the edge.

The white ceramic glass may further include: a chemically reinforced area that may have a depth of 100 μm or less from a surface of the white ceramic glass.

The plurality of micro recesses may be in a surface of the white ceramic glass, the surface may be an elastomer particle blasted, etched, and polished surface.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF DRAWINGS

FIG. 1 is a perspective view illustrating a cooktop according to an embodiment.

FIG. 2 is an exploded perspective view illustrating a cooktop according to an embodiment.

FIG. 3 is a cross-sectional view illustrating a white ceramic glass according to an embodiment.

FIG. 4 is a flowchart illustrating a manufacturing process of a white ceramic glass according to an embodiment.

FIG. 5 illustrates an experimental example for describing a surface state of a white ceramic glass according to an embodiment.

FIG. 6A illustrates an experimental example in which a surface of a white ceramic glass is observed from thereabove using an electron microscope.

FIG. 6B illustrates an experimental example in which a side surface of a surface of a micro recess in a white ceramic glass is observed using an electron microscope.

FIG. 7 illustrates an experimental example illustrating scratch resistance of a white ceramic glass according to an embodiment.

FIG. 8 is a perspective view illustrating a white ceramic glass having a perforated portion and a display device according to an embodiment.

FIG. 9 is a flowchart illustrating a method for manufacturing a white ceramic glass according to an embodiment.

FIG. 10 is a cross-sectional view illustrating the white ceramic glass of FIG. 8.

FIG. 11 is a cross-sectional view taken along line C-C′ of FIG. 8.

Reference may be made to the accompanying drawings in the following description, and specific examples that may be practiced are shown as examples within the drawings. Other examples may be utilized and structural changes may be made without departing from the scope of the various examples.

### MODE FOR THE INVENTION

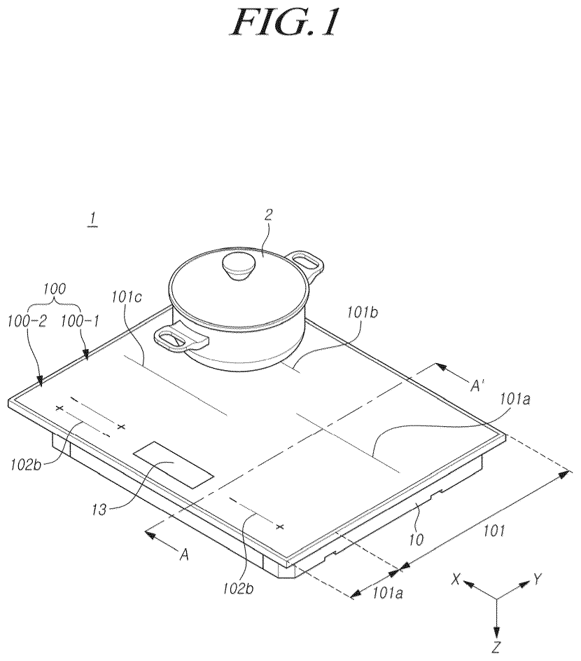

Various embodiments of the disclosure are merely exemplified herein with reference to FIGS. 1 to 11, to describe the principle of the disclosure, and should not be interpreted as limiting the scope of the disclosure. Those skilled in the art will understand that the principle of the disclosure may be implemented in any appropriately disposed system or device.

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

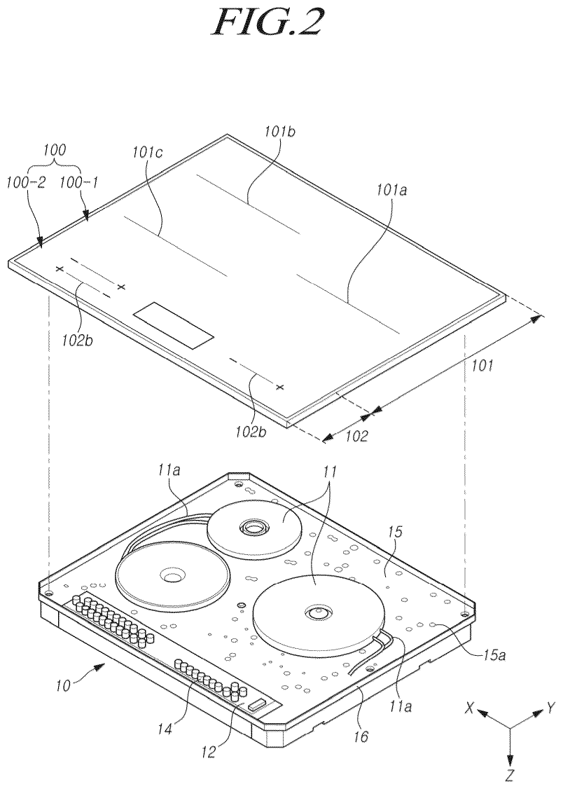

FIG. 1 is a perspective view illustrating a cooktop according to an embodiment. FIG. 2 is an exploded perspective view illustrating a cooktop according to an embodiment.

The drawings of the cooktop (or cooking device) illustrated in FIGS. 1 and 2 are exemplary for convenience of description, and the scope of the disclosure is not limited by the shape and structure illustrated.

Referring to FIGS. 1 and 2, the cooktop 1 according to an embodiment may include a cooktop body 10 and a white ceramic glass 100. The white ceramic glass 100 may be disposed on the cooktop body 10. The cooktop 1 according to an embodiment may include at least one of a heater (hereinafter, referred to as an induction heating coil 11), a circuit board 12, or a coil seating plate 15. Here, the cooktop 1 may be referred to as a cooking device.

According to an embodiment, the main body 10 may form the appearance of the cooktop 1. The induction heating coil 11 may be received in the main body 10. The induction heating coil 11 may generate a magnetic field to inductively heat the cooking container 2 in the main body 10. The induction heating coil 11 may be electrically connected to the main substrate disposed inside the main body 10 through an electric line 11a.

According to an embodiment, the white ceramic glass 100 may include a first glass 100-1 forming a first area 101 and a second glass 100-2 forming a second area 102. The first glass 100-1 and the second glass 100-2 may be integrally formed. However, the disclosure is not limited thereto, and the first glass 100-1 and the second glass 100-2 may be coupled to each other by a separate coupling device.

According to an embodiment, printing layers 101a, 101b, and 101c may be included on the first glass 100-1. The printing layers 101a, 101b, and 101c positioned on the first glass 100-1 may be coated at positions corresponding to the induction heating coil 11 to guide the heating area. The shapes of the printing layers 101a, 101b, and 101c are not limited to those illustrated.

According to an embodiment, the second glass 100-2 may include an input unit 102b. The input unit 102b may be positioned in the second area 102 of the white ceramic glass 100, but the disclosure is not limited thereto. The input unit 102b may be formed at a position corresponding to the touch unit 14. The input unit 102b may be formed to vertically overlap the touch unit 14. The user may adjust the current flowing through the induction heating coil 11 through the input unit 102b. For example, the user may determine the degree to which the cooking container 2 is heated through the input unit 102b.

According to an embodiment, the circuit board 12 may be disposed under the second glass 100-2.

According to an embodiment, the cooktop 1 may include a display device 13. The display device 13 may be disposed in the second area 102, but the disclosure is not limited thereto. The display device 13 may be electrically connected to the circuit board 12. The display device 13 may be disposed in a through hole where the white ceramic glass 100 is formed through the second area 102. For example, the display device 13 may display whether the cooking container 2 is heated by the induction heating coil 11. The user may identify whether the cooking container 2 is heated through the display device 13. For example, the display device 13 may display visual information such as letters, numbers, images, or videos.

According to an embodiment, the cooktop 1 may include a touch unit 14. The touch unit 14 may be disposed in the second area 102, but the disclosure is not limited thereto. The touch unit 14 may be electrically connected to the circuit board 12. The touch unit 14 may receive a touch signal. For example, the touch unit 14 may receive an input through a capacitive touch method. However, the disclosure is not limited thereto, and the touch unit 14 may also receive an input in a resistive touch method. The user may adjust the current flowing through the induction heating coil 11 through the touch unit 14 and determine the degree to which the cooking container 2 is heated.

According to an embodiment, the induction heating coil 11 may be mounted on the coil seating plate 15. The coil seating plate 15 may be received in the cooktop body 10. The coil seating plate 15 may be provided with a coil seating recess 15a for seating the induction heating coil 11. A plurality of coil seating recesses 15a may be provided.

According to an embodiment, the cooktop body 10 may include a first frame 16 disposed to support the white ceramic glass 100. The first frame 16 may be provided so that the white ceramic glass 100 is supported thereon. The first frame 16 may be formed to extend in the upper direction from the four side ends of the coil seating plate 15. The first frame 16 may be disposed to surround the edge of the coil seating plate 15. The first frame 16 may be disposed to allow the white ceramic glass 100 to be seated on and supported on the cooktop body 10.

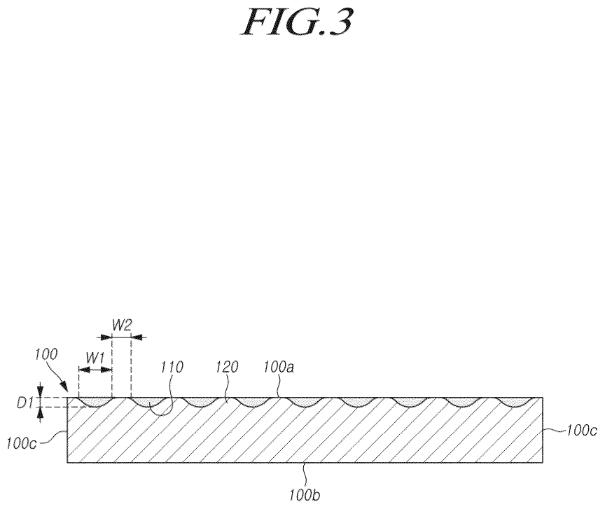

The structure of the white ceramic glass 100 included in the cooktop 1 is described below with reference to FIG. 3.

FIG. 3 is a cross-sectional view illustrating a white ceramic glass according to an embodiment.

In FIG. 3, for convenience of description, the sizes of the micro recesses 110 and the embossed portions 120 may be slightly exaggerated. FIG. 3 is exemplary for convenience of description, and the illustrated cross-sectional shape does not limit the scope of the disclosure.

Referring to FIG. 3, the white ceramic glass 100 according to an embodiment may include an upper surface 100a, a lower surface 100b, and a side surface 100c. The upper surface 100a may be a surface exposed to the outside when the white ceramic glass 100 is mounted on the cooktop (e.g., the cooktop 1 of FIG. 1). The lower surface 100b is a surface opposite to the upper surface 100b, and may face the inside of the main body (e.g., the main body 10 of FIG. 1) when mounted on the cooktop 1. The side surface 100c may be a surface connecting the upper surface 100a and the lower surface 100b. The side surface 100c may extend in a vertical direction from an edge of the upper surface 100a. The side surface 100c may extend in a vertical direction from an edge of the lower surface 100b.

According to an embodiment, the white ceramic glass 100 may be formed of an opaque material. The white ceramic glass 100, unlike the black ceramic glass or transparent ceramic glass, does not have a separate color coating layer. The white ceramic glass 100 itself may have a substantially white color.

According to an embodiment, the white ceramic glass 100 may include Al₂O₃ of 18 to 24 wt %, and SiO₂ of 60 to 70 wt %.

Al₂O₃ may play a role to enhance corrosion resistance and durability of the ceramic glass. When the content of Al₂O₃ is low, corrosion resistance and durability of ceramic glass may deteriorate. However, if the content of Al₂O₃ is excessive, the manufacturing cost may increase.

SiO₂ may serve as a nucleation agent in the ceramic glass. When the content of SiO₂ is low, crystals in the ceramic glass are not sufficiently generated, and thus reflectance may be lowered. However, if the SiO₂ content is excessive, the hardness and durability of the ceramic glass may decrease.

According to an embodiment, the white ceramic glass 100 may include various compositions such as MgO, TiO₂, ZrO₂, Li₂O, BaO and/or ZnO.

According to an embodiment, the white ceramic glass 100 may include an upper printing layer. The upper printing layer may include at least one of a UX printing layer and a UI printing layer. The upper printing layer may be positioned on the upper surface 100a. It may be formed to mark the center of the burner area on the top. The upper printing layer may be formed in a straight or cross shape to mark the center of the burner area, but the disclosure is not limited thereto. Here, the upper printing layer may form the printing layer of FIG. 1 (e.g., the printing layers 101a, 101b, and 101c of FIG. 1) or an input unit (e.g., the input unit 102b of FIG. 1).

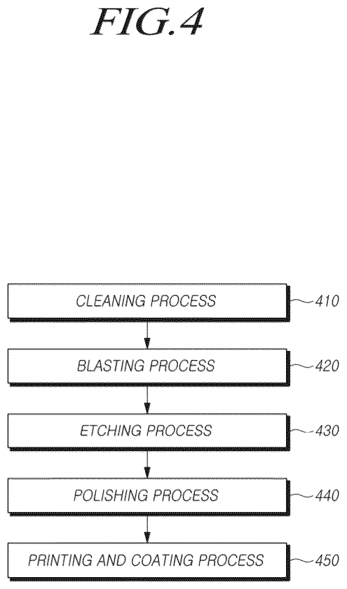

According to an embodiment, the white ceramic glass 100 may include a plurality of micro recesses 110 or a plurality of embossed portions 120. The plurality of micro recesses 110 and the plurality of embossed portions 120 may be formed on the upper surface 100a of the white ceramic glass 100. For example, the upper surface 100a of the white ceramic glass 100 may be composed of a plurality of micro recesses 110 and a plurality of embossed portions 120. The plurality of micro recesses 110 and the plurality of embossed portions 120 may be formed through a blasting process, a chemical etching process, and a polishing process to be described below in connection with FIG. 4.

According to an embodiment, the plurality of micro recesses 110 may be formed between the plurality of embossed portions 120. The plurality of micro recesses 110 may be formed by a blasting process and an etching process to be described below. Here, the micro recess 110 may be referred to as a recess, a micro dimple, an intaglio portion, or a concave portion.

According to an embodiment, the plurality of micro recesses 110 may have a depth D1 of 30 μm or less on average. The plurality of micro recesses 110 may have different depths. Here, the depth D1 of the micro recess 110 may be measured with respect to the upper end of the embossed portion 120 adjacent to the micro recess 110 and the lower end of the micro recess 110. For example, the depth D1 of the plurality of micro recesses 110 may refer to the average depth of all of the micro recesses 110 in the entire area of the upper surface 100a of the white ceramic glass 100. For example, the depth D1 of the plurality of micro recesses 110 may denote the average depth of 10 to 20 micro recesses 110 arbitrarily selected from each of a plurality of virtual areas into which the upper surface 100a of the white ceramic glass 100 is divided. However, the method of measuring the average depth D1 of the plurality of micro recesses 110 is not limited thereto.

As the average depth D1 of the plurality of micro recesses 110 increases, the cleaning efficiency (or ease of cleaning) of the white ceramic glass 100 may deteriorate. When the foreign object flows into the deeply formed micro recesses, it may be difficult for the user to easily remove the foreign objects by cleaning. The average depth D1 of the micro recesses 110 formed in the white ceramic glass 100 of the disclosure is 30 μm or less, and thus cleaning efficiency may be enhanced.

According to an embodiment, the average width W1 of the plurality of micro recesses 110 may be 100 μm or more. Each of the plurality of micro recesses 110 may have a different width. Here, the width W1 of the micro recess 110 may refer to a distance between the embossed portions 120 adjacent to the micro recess 110. For example, the width W1 of the plurality of micro recesses 110 may refer to the average width of all of the micro recesses 110 in the entire area of the upper surface 100a of the white ceramic glass 100. For example, the width W1 of the plurality of micro recesses 110 may denote the average width of 10 to 20 micro recesses 110 arbitrarily selected from each of a plurality of virtual areas into which the upper surface 100a of the white ceramic glass 100 is divided. However, the method of measuring the average width W1 of the plurality of micro recesses 110 is not limited thereto.

As the average width W1 of a plurality of micro recesses 110 decreases, the cleaning efficiency of the white ceramic glass 100 may deteriorate. When the foreign object flows into the micro recess having a narrow width, it is difficult to remove the foreign object from the micro recess. The average width W1 of the micro recess 110 formed in the white ceramic glass 100 of the disclosure is 100 μm or more, and cleaning efficiency may be enhanced.

According to an embodiment, the plurality of embossed portions 120 may be formed to protrude upward between the plurality of micro recesses 110. Here, the embossed portion 120 may be referred to as an embossing, an embossing portion, or a protruding portion.

The sizes of the plurality of embossed portions 120 are related to scratch resistance (anti-scratch property). As the area of the embossed portion 120 increases, the resistance to scratches to the white ceramic glass 100 may increase. As the area of the embossed portion 120 increases, the area of the micro recess 110 decreases relatively, and thus the cleaning efficiency may decrease.

The white ceramic glass 100 according to an embodiment may have a size range of the embossed portion 120 for optimizing cleaning efficiency and scratch resistance.

According to an embodiment, the plurality of embossed portions 120 may have an average width W2 of 80 μm to 130 μm. Each of the plurality of embossed portions 120 may have a different width. Here, the width W2 of the embossed portion 120 may refer to a diameter of the embossed portion 120. For example, the width W2 of the plurality of embossed portions 120 may refer to the average width of all of the embossed portions 120 in the entire area of the upper surface 100a of the white ceramic glass 100. For example, the width W2 of the plurality of embossed portions 120 may denote the average width of 10 to 20 embossed portions 120 arbitrarily selected from each of a plurality of virtual areas into which the upper surface 100a of the white ceramic glass 100 is divided. However, the method of measuring the average width W2 of the plurality of embossed portions 120 is not limited thereto.

According to an embodiment, the surface roughness of the white ceramic glass 100 may be 1.5 μm to 2.5 μm. The surface roughness of the upper surface 100a of the white ceramic glass 100 may be 1.5 μm to 2.5 μm. The cleaning efficiency may be enhanced by forming a lower surface roughness of the white ceramic glass 100.

According to an embodiment, the upper surface 100a of the white ceramic glass 100 may be coated with a coating material. A coating layer is formed on the upper surface 100a of the white ceramic glass 100, enhancing antifouling and heat resistance.

In the ceramic glass 100 according to an embodiment, the average depth D1 and the average width W1 of the plurality of micro recesses 110, the average width W2 of the plurality of embossed portions 120, and the average roughness of the surface may be formed by the process to be described below in FIG. 4.

FIG. 4 is a flowchart illustrating a manufacturing process of a white ceramic glass according to an embodiment.

The flowchart illustrated in FIG. 4 is exemplary, and some of the illustrated processes may be omitted or other processes may be added to the illustrated processes.

The manufacturing process of FIG. 4 may be a manufacturing process of the white ceramic glass (e.g., the white ceramic glass 100 of FIG. 1) illustrated in FIGS. 1 to 3.

Referring to FIG. 4, a method for manufacturing a white ceramic glass 100 may include a cleaning process 410, a blasting process 420, an etching process 430, a polishing process 440, and a printing and coating process 450.

The white ceramic glass 100 has a different crystal structure and composition from that of the black ceramic glass or transparent ceramic glass. Therefore, if a manufacturing process of forming a plurality of micro recesses in a black ceramic glass or transparent ceramic glass is applied to the white ceramic glass 100, a low-quality white ceramic glass 100 with poor scratch resistance (or wear resistance) and poor cleaning efficiency (or ease of cleaning) may be manufactured. For example, the white ceramic glass 100 has a beta-spodumene crystal structure, and the diameter of the crystal structure is about 0.9 μm to 1.1 μm, which may be larger than the diameter of black ceramic glass or transparent ceramic glass crystal structure. Due to the differences, a new manufacturing process should be applied to manufacture a white ceramic glass 100 with enhanced scratch resistance and cleaning efficiency.

According to an embodiment, the method for manufacturing the white ceramic glass may include a cleaning process 410. In the cleaning process 410, the surface of the base material of the white ceramic glass cut to an appropriate size may be cleaned. The surface of the base material of the white ceramic glass may be cleaned before performing blasting, etching, and polishing processes to be described below.

According to an embodiment, the method for manufacturing the white ceramic glass may include a blasting process 420. In the blasting process 420, the elastomer may be used as media and sprayed onto the surface of the white ceramic glass. The media may be sprayed onto the upper surface of the white ceramic glass. Elastomer particles may be sprayed onto the surface of the white ceramic glass at high speed in the blasting process 420.

Sandblasting was used in the process of forming micro recesses in the conventional ceramic glass for cooktops. However, if sandblasting is used in the white ceramic glass, a rough and uneven surface may be formed due to, e.g., differences in crystal structure size.

In the disclosure, the surface of the white ceramic glass 100 according to an embodiment may be formed through an elastic blasting process using an elastomer as media instead of sand blasting.

According to an embodiment, the media used as the elastomer in the blasting process 420 may have a silicon elastomer coated on at least one of aluminum oxide (Al₂O₃), silicon carbide (SiC), cerium oxide (CeO₂), silicon dioxide (SiO₂), chromium dioxide (CrO₂), lanthanum oxide (La₂O₃), boron carbide (B₄C), or zirconium oxide (ZrO₂).

When the blasting process 420 is completed, the surface roughness Ra of the surface of the white ceramic glass sprayed with the medium may be 0.5 μm to 1.5 μm.

According to an embodiment, the method for manufacturing the white ceramic glass may include an etching process 430. In the etching process 430, the white ceramic glass that has undergone the blasting process 410 may be immersed in a hydrofluoric acid (HF) solution. The average depth (e.g., the average depth D1 of FIG. 3) of the micro recesses 110 may be determined according to the time for chemically etching the white ceramic glass in the etching process 430. As the chemical etching time increases, the average depth D1 of the micro recess 110 may increase. In the disclosure, chemical etching may be performed within 1 hour to form the micro recesses 110 so that the average depth D1 of the micro recesses 110 is 30 μm or less. For example, the etching process 430 may be performed for 20 to 40 minutes, but the disclosure is not limited thereto.

After the etching process is completed, the surface roughness Ra of the white ceramic glass may be in a range of about 1.5 μm to about 2.5 μm.

According to an embodiment, the method for manufacturing the white ceramic glass may include a polishing process 440. The polishing process 440 may be repeated two or three times. A different type of polishing pads may be used for each turn of the polishing process 440. For example, a soft polishing pad and a hard polishing pad may be used alternately for each turn of the polishing process 440, but the disclosure is not limited thereto. When the polishing process 440 is completed, the white ceramic glass may have a surface roughness Ra of about 1.5 μm to about 2.5 μm.

When the blasting process, the etching process, and the polishing process are performed in the above-described manner, a plurality of micro recesses 110 having an average width W1 of 100 μm or more and an average depth D1 of 30 μm or less, and a plurality of embossed portions 120 having an average width W2 of 80 μm to 130 μm may be formed on the upper surface 100a of the white ceramic glass 100.

According to an embodiment, the method for manufacturing the white ceramic glass may include a printing and coating process 450. The upper printing layer may be printed in the printing and coating process 450. In the printing and coating process 450, the upper surface of the white ceramic glass may be coated with a coating material.

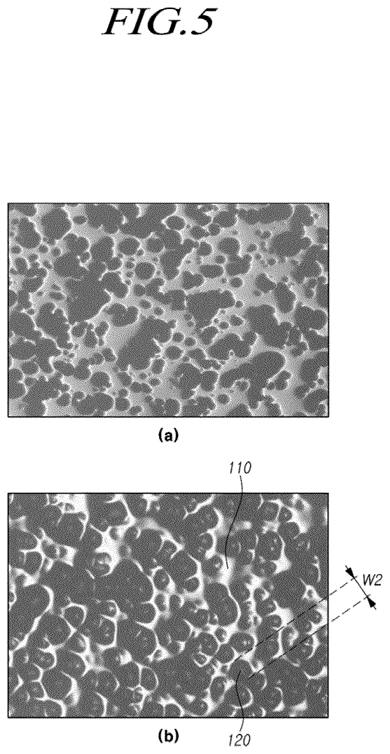

FIG. 5 illustrates an experimental example for describing a surface state of a white ceramic glass according to an embodiment.

FIG. 5(a) is an image of the surface of the white ceramic glass to which a process used to form micro recesses in black ceramic glass or transparent ceramic glass is applied. FIG. 5(b) is an image obtained by capturing the surface of the white ceramic glass (e.g., the white ceramic glass 100 of FIG. 3) according to an embodiment. FIG. 5(b) is an image obtained by capturing the surface of the white ceramic glass 100 to which the manufacturing method of FIG. 4 is applied.

The size distribution of circular micro recesses shown in FIG. 5(a) is uneven than the size distribution of circular micro recesses shown in FIG. 5(b). In other words, micro recesses having high size uniformity may be formed even in white ceramic glass by applying the new process illustrated in FIG. 4.

When the size distribution of the micro recesses is uneven, embossed portions may be formed in a very small size as illustrated in FIG. 5(a). When the size of the embossed portion decreases, the scratch resistance of the white ceramic glass may decrease. As illustrated in FIG. 5(b), the white ceramic glass 100 according to an embodiment of the disclosure has a relatively more uniform size of the embossed portion 120 and an average width W2 of 80 μm to 130 μm, thereby enhancing scratch resistance.

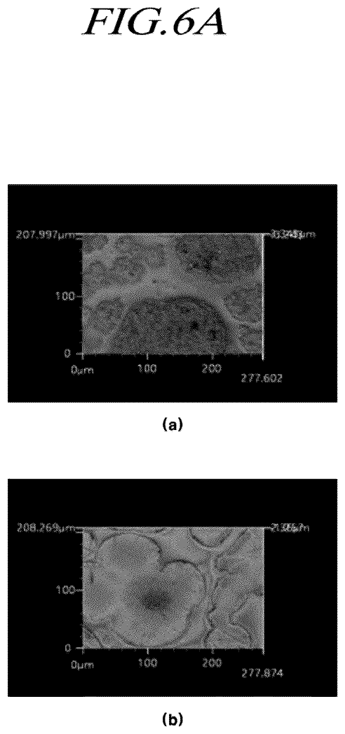

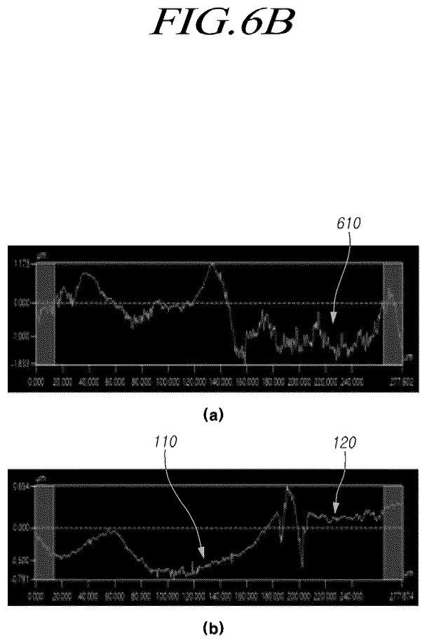

FIG. 6A illustrates an experimental example in which a surface of a white ceramic glass is observed from thereabove using an electron microscope. FIG. 6B illustrates an experimental example in which a side surface of a surface of a micro recess in a white ceramic glass is observed using an electron microscope.

FIG. 6A(a) is an image (hereinafter, a ‘first image’) of a portion of the surface of the white ceramic glass to which a process used to form micro recesses in black ceramic glass or transparent ceramic glass is applied, captured from thereabove using an electron microscope. FIG. 6A(b) is an image of a portion of the surface of the white ceramic glass (e.g., the white ceramic glass 100 of FIG. 3) according to an embodiment, captured from thereabove using an electron microscope. FIG. 6A(b) is an image (hereinafter, a ‘second image’) of a portion of the surface of the white ceramic glass 100 to which the manufacturing method of FIG. 4 is applied, captured from thereabove using an electron microscope.

Referring to FIG. 6A, it may be identified that the surface of the first image is rougher than the surface of the second image. If the surface is rough, scratch resistance and cleaning efficiency may decrease, deteriorating marketability. The first image may be observed to have an uneven surface, such as a textured surface. If fine foreign objects are stuck in the textured surface, even if the user wipes the surface of the white ceramic glass, the foreign objects may be difficult to remove, deteriorating cleaning efficiency. The second image may be observed to have a relatively softer surface compared to the first image. Such surface properties may enhance cleaning efficiency of the white ceramic glass 100.

FIG. 6B(a) is data (hereinafter, ‘first data’) for a portion of the side cross section of the white ceramic glass to which a process used to form micro recesses in black ceramic glass or transparent ceramic glass is applied, measured using an electron microscope. FIG. 6B(b) is data for a portion of the side cross section of the white ceramic glass (e.g., the white ceramic glass 100 of FIG. 3) according to an embodiment, measured using an electron microscope. FIG. 6B(b) is data (hereinafter, ‘second data’) for a portion of the side cross section of the white ceramic glass 100 to which the manufacturing method of FIG. 4 is applied, measured using an electron microscope.

Through the first data and the second data, a schematic side cross-sectional view of each ceramic glass may be identified. Referring to the first data, a small protruding shape in the micro recess 610 may be identified. When such protruding shapes are formed, foreign objects of a fine size may be stuck between the protruding shapes, deteriorating cleaning efficiency. Referring to the second data, it may be identified that a surface with relatively smoother micro recesses 110 is formed. From the second data as compared with the first data, the number of spaces such as fine gaps where fine foreign objects may be stuck inside the micro recesses 110 may be significantly reduced.

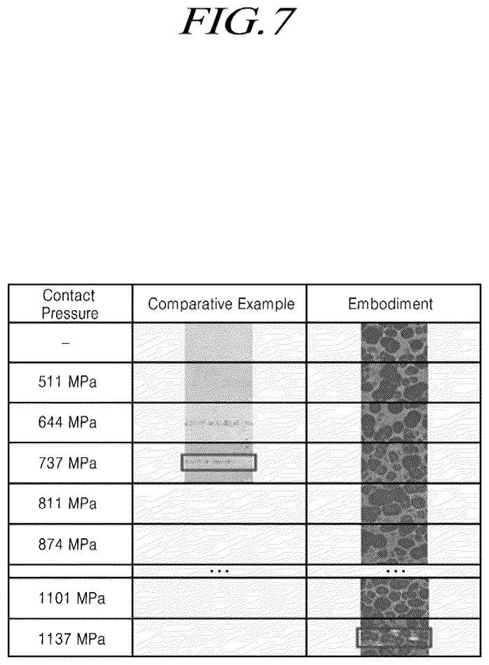

FIG. 7 illustrates an experimental example illustrating scratch resistance of a white ceramic glass according to an embodiment.

FIG. 7 compares scratch resistance between the white ceramic glass according to the comparative example and the white ceramic glass (e.g., the white ceramic glass 100 of FIG. 3) according to an embodiment. Here, the comparative example is a general white ceramic glass, which does not have micro recesses.

The comparative example of FIG. 7 is a white ceramic glass in a state where micro recesses are not formed. The embodiment of FIG. 7 is a white ceramic glass 100 according to an embodiment of the disclosure.

In the experiment of FIG. 7, the presence or absence of scratches was tested by applying a constant pressure to the surface of each material using a stainless ball.

The white ceramic glass 100 according to an embodiment may have excellent scratch resistance as well as cleaning efficiency.

Referring to FIG. 7, the white ceramic glass of the comparative example had a surface scratch at a contact pressure of 737 MPa. The white ceramic glass 100 of the embodiment had a surface scratch at a contact pressure of 1137 MPa. The embodiment may have scratch resistance that is about 1.54 times stronger than that of the comparative example.

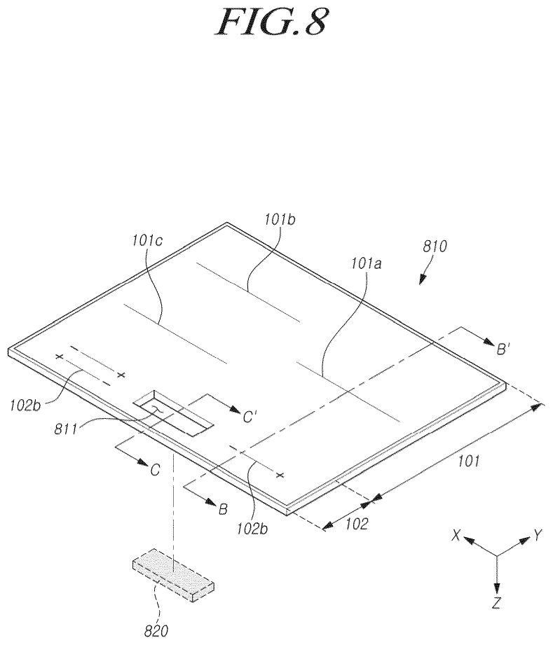

FIG. 8 is a perspective view illustrating a white ceramic glass having a perforated portion and a display device according to an embodiment.

The white ceramic glass 810 and the display device 820 illustrated in FIG. 8 may be included in the cooktop (e.g., the cooktop 1 of FIG. 1) of FIGS. 1 and 2. The white ceramic glass 810 of FIG. 8 may be disposed on the cooktop 1 in place of the white ceramic glass 100 of FIG. 1.

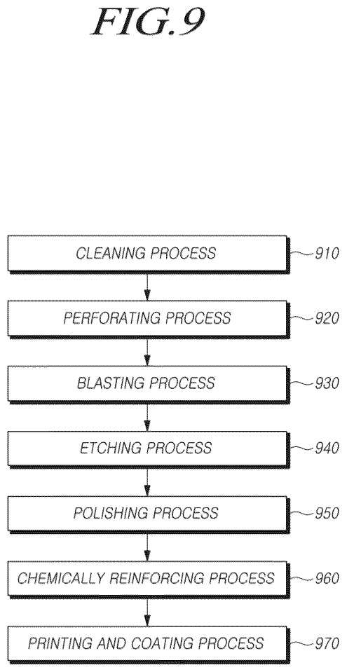

The embodiment of FIG. 8 may be selectively combined with the embodiments of FIGS. 1 to 4. The embodiment of FIG. 8 may be selectively combined with the embodiments of FIGS. 9 to 11.

The same reference numbers are used to denote substantially the same components as the above-described components among the components of FIG. 8.

According to an embodiment, the cooktop may include a white ceramic glass 810 and a display device 820.

According to an embodiment, the white ceramic glass 810 may include a through hole 811. The through hole 811 may be formed in a place corresponding to the display device 820. The through hole 811 may be formed to vertically overlap the display device 820.

According to an embodiment, the display device 820 may be disposed under the through hole 811. However, the disclosure is not limited thereto, and the display device 820 may be fitted and fixed by the edge of the through hole 811, so that a portion thereof may protrude upward of the white ceramic glass 810. Here, the display device 820 may display visual information such as an image, a video, or text. The display device 820 may be, e.g., a liquid crystal display (LCD), an organic light emitting diode (OLED) display, a micro LED display, an LED display, an E-Ink display, or a quantum-dot display.

The white ceramic glass 810 according to an embodiment may be formed of an opaque material through which light may not pass, unlike other black ceramic glasses or transparent ceramic glasses. Therefore, in order to dispose the display device 820 for providing visual information to the user toward the upper portion of the cooktop, the white ceramic glass 810 may be perforated to form the through hole 811.

By forming the through hole 811 in the white ceramic glass 810 according to an embodiment and disposing the display device 820 for providing various visual information to the user, the cooktop (e.g., the cooktop 1 of FIG. 1) may provide not only numbers indicating the degree of heating but also other various visual information without limitation.

FIG. 9 is a flowchart illustrating a method for manufacturing a white ceramic glass according to an embodiment.

The flowchart illustrated in FIG. 9 is exemplary, and some of the illustrated processes may be omitted or other processes may be added to the illustrated processes.

The manufacturing process of FIG. 9 may be a manufacturing process of the white ceramic glass (e.g., the white ceramic glass 810 of FIG. 8) illustrated in FIG. 8.

Referring to FIG. 9, the method for manufacturing white ceramic glass 810 may include a cleaning process 910, a perforating process 920, a blasting process 930, an etching process 940, a polishing process 950, a chemically reinforcing process 960, and a printing and coating process 970.

The cleaning process 910 may be performed in substantially the same manner as the cleaning process of FIG. 4 (e.g., the cleaning process 410 of FIG. 4). The blasting process 930 may be performed in substantially the same manner as the blasting process of FIG. 4 (e.g., the blasting process 420 of FIG. 4). The etching process 940 may be performed in substantially the same manner as the etching process of FIG. 4 (e.g., the etching process 430 of FIG. 4). The polishing process 950 may be performed in substantially the same manner as the polishing process 440 of FIG. 4. The printing and coating process 970 may be performed in substantially the same manner as the printing and coating process 450 of FIG. 4.

According to an embodiment, the method for manufacturing the white ceramic glass may include a perforating process 920. The perforating process 920 may be performed before the blasting process 930. The perforating process 920 may be a process of forming a through hole by perforating a specific area of the white ceramic glass. Here, the specific area may refer to an area corresponding to the above-described display device (e.g., the display device 820 of FIG. 8). However, the disclosure is not limited thereto, and perforation may be performed in a plurality of areas in the white ceramic glass for various purposes other than the purpose of disposing the display device 820.

According to an embodiment, the method for manufacturing the white ceramic glass may include a chemically reinforcing process 960. The chemically reinforcing process 960 may be performed after the polishing process 950 is completed. The chemically reinforcing process 960 may be performed using NaNO₃ or KNO₃ as the reinforcing salt at 350 to 450° C. for 2 to 5 hours. According to an embodiment, the chemically reinforcing process 960 may be performed to increase compressive stress of the white ceramic glass.

According to an embodiment, the chemically reinforcing process 960 may be performed twice. It may be carried out at a time interval between the two chemically reinforcing processes.

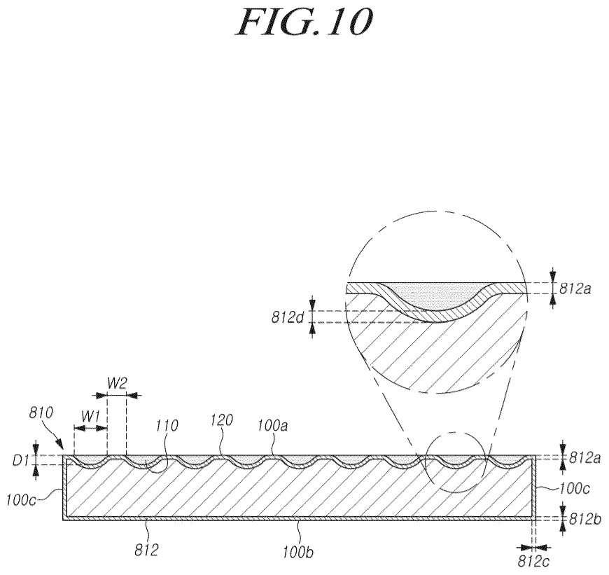

FIG. 10 is a cross-sectional view illustrating the white ceramic glass of FIG. 8.

FIG. 10 is a cross-sectional view taken along line B-B′ of FIG. 8.

In FIG. 10, for convenience of description, the size of the micro recess 110 and the embossed portion 120 and the size of the chemically reinforced area 812 may be slightly exaggerated. FIG. 10 is exemplary for convenience of description, and the illustrated cross-sectional shape does not limit the scope of the disclosure.

The same reference numbers are used to denote substantially the same components as the above-described components among the components of FIG. 10.

The embodiment of FIG. 10 may be selectively combined with the embodiments of FIGS. 1 to 9.

Referring to FIG. 10, the white ceramic glass 810 may further include a chemically reinforced area 812. When a through hole 811 is formed in the white ceramic glass 810 by the perforating process, the white ceramic glass 810 may be easily damaged from external impact due to weakened compressive stress. To compensate for the rigidity of the white ceramic glass 810, the surface of the white ceramic glass 810 may be chemically reinforced through a chemically reinforcing process (e.g., the chemically reinforcing process 960 of FIG. 9).

According to an embodiment, the chemically reinforced area 812 may have a depth of 100 μm or less from the surface. The depth of 100 μm or less may refer to an average depth of the chemically reinforced area 812. The chemically reinforced area 812 may be formed from the surface of the white ceramic glass 810 toward the inside of the white ceramic glass 810.

According to an embodiment, the depth 812a of the chemically reinforced area 812 measured from the upper surface 100a of the white ceramic glass 810 may be 100 μm or less.

According to an embodiment, the depth 812b of the chemically reinforced area 812 measured from the lower surface 100b of the white ceramic glass 810 may be 100 μm or less.

According to an embodiment, the depth 812c of the chemically reinforced area 812 measured from the side surface 100c of the white ceramic glass 810 may be 100 μm or less.

According to an embodiment, the depth 812d of the chemically reinforced area 812 measured from the lower end of the micro recess 110 of the white ceramic glass 810 may be 100 μm or less.

As illustrated, by chemically reinforcing the surface of the white ceramic glass 810, even when the through hole 811 is formed by perforating a specific area of the white ceramic glass 810, it may have high rigidity. Even when an impact is applied to the periphery of the through hole 811, it may not be easily damaged by the chemically reinforced area 812.

According to an embodiment, the white ceramic glass of FIG. 3 (e.g., the white ceramic glass 100 of FIG. 3) may also have a cross-section substantially the same as the cross-sectional structure illustrated in FIG. 10. In other words, the white ceramic glass 100 of FIG. 3 may also include a chemically reinforced area as illustrated in FIG. 10.

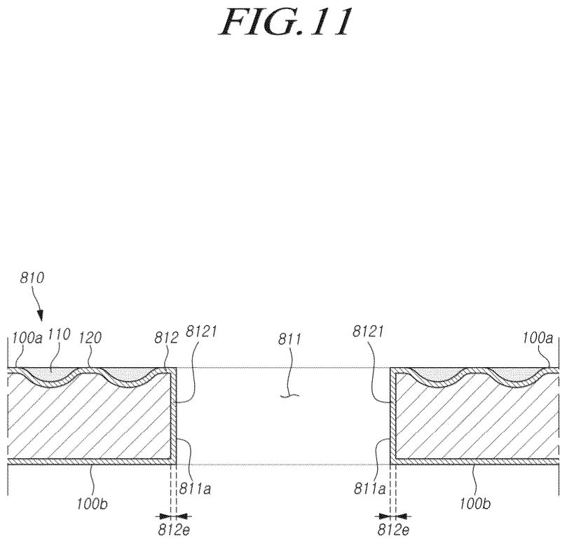

FIG. 11 is a cross-sectional view taken along line C-C′ of FIG. 8.

In FIG. 11, for convenience of description, the size of the micro recess 110 and the embossed portion 120 and the size of the chemically reinforced area 812 may be slightly exaggerated. FIG. 11 is exemplary for convenience of description, and the illustrated cross-sectional shape does not limit the scope of the disclosure.

The same reference numbers are used to denote substantially the same components as the above-described components among the components of FIG. 11.

The embodiment of FIG. 11 may be selectively combined with the embodiments of FIGS. 1 to 10.

Referring to FIG. 11, the white ceramic glass 810 may further include an edge reinforcement area 8121. The edge reinforcement area 8121 may be a portion of the chemically reinforced area 812.

According to an embodiment, the edge reinforcement area 8121 may have a depth 812e of 100 μm or less from the side surface 811a (or edge surface) of the edge forming the through hole 811. The edge reinforcement area 8121 may be formed from the side surface 811a of the through hole 811 toward the inside of the white ceramic glass 810.

By forming the edge reinforcement area 8121, it is possible to reduce the frequency of damage to the periphery of the through hole 811 by an impact through the side surface 811a of the through hole 811.

A cooktop according to an embodiment may comprise a cooktop body 10, and a white ceramic glass 100, 810 disposed on an upper portion of the cooktop body 10. The white ceramic glass 100, 810 may include a plurality of micro recesses 110 having a depth D1 of 30 μm or less on average, and a plurality of embossed portions 120 formed to protrude upward between the plurality of micro recesses 110 and having a width W2 of 80 μm to 130 μm on average.

According to an embodiment, a surface roughness Ra of the white ceramic glass may be 1.5 μm to 2.5 μm.

According to an embodiment, an average width W1 of the plurality of micro recesses 110 may be 100 μm or more.

According to an embodiment, an upper surface of the white ceramic glass 100, 810 may be coated with a coating material.

According to an embodiment, the white ceramic glass 100, 810 may include a beta-spodumene crystal structure.

According to an embodiment, a diameter of a crystal constituting the white ceramic glass 100, 810 may be 0.9 μm to 1.1 μm.

According to an embodiment, the micro recess 110 may be formed through a blasting process, a chemical etching process, and a polishing process using an elastomer as media.

According to an embodiment, the white ceramic glass 100, 810 may undergo a chemical reinforcing process to increase compressive stress.

According to an embodiment, the cooktop may further comprise a display device 820 disposed on a lower side of the white ceramic glass 100, 810. The white ceramic glass 100, 810 may include a through hole 811 formed through a portion corresponding to the display device 820.

According to an embodiment, the white ceramic glass 100, 810 may include an edge reinforcement area 8121 having a depth of 100 μm or less from a side surface of an edge forming the through hole 811.

According to an embodiment, the media used as the elastomer in the blasting process may have a silicon elastomer coated on at least one of aluminum oxide (Al₂O₃), silicon carbide (SiC), cerium oxide (CeO₂), silicon dioxide (SiO₂), chromium dioxide (CrO₂), lanthanum oxide (La₂O₃), boron carbide (B₄C), or zirconium oxide (ZrO₂).

According to an embodiment, the white ceramic glass 100, 810 may include a chemically reinforced area 812 having a depth of 100 μm or less from a surface.

A method for manufacturing a white ceramic glass 100, 810, according to an embodiment, may comprise a blasting process spraying elastomer particles onto a surface of the white ceramic glass 100, 810 at a high speed, an etching process exposing the white ceramic glass 100, 810 that has undergone the blasting process to a hydrofluoric acid HF solution, and a polishing process polishing a surface of the white ceramic glass 100, 810 that has undergone the etching process two to three times to form a surface roughness of 1.5 μm to 2.5 μm.

According to an embodiment, the method may comprise, before the blasting process, performing a perforation process perforating a predetermined area.

According to an embodiment, the method may comprise a chemically reinforcing process chemically reinforcing the white ceramic glass 100, 810 that has undergone the polishing process.

A white ceramic glass 100, 810 according to an embodiment may comprise a plurality of micro recesses 110 formed in an upper surface to have a depth of 30 μm or less on average, and a plurality of embossed portions 120 formed between the plurality of micro recesses 110 and having a width of 80 μm to 130 μm on average. A surface roughness Ra of the upper surface may be 1.5 μm to 2.5 μm.

According to an embodiment, a crystal structure of the white ceramic glass 100, 810 may include a beta-spodumene crystal structure. A diameter of the crystal structure may be 0.9 μm to 1.1 μm.

According to an embodiment, the white ceramic glass may further comprise a through hole 811 having a portion penetrated vertically. The white ceramic glass may comprise an edge reinforcement area 8121 having a depth of 100 μm or less from a side surface of an edge forming the through hole 811.

According to an embodiment, the white ceramic glass may comprise a chemically reinforced area 812 having a depth of 100 μm or less from a surface.

According to an embodiment, the micro recess 110 may be formed through a blasting process, a chemical etching process, and a polishing process using an elastomer as media.

The terms as used herein are provided merely to describe some embodiments thereof, but are not intended to limit the disclosure. As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, the terms “first” and “second” may modify various components regardless of importance and/or order and are used to distinguish a component from another without limiting the components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms “upper side”, “lower side”, and “front and rear directions” used in the disclosure are defined with respect to the drawings, and the shape and position of each component are not limited by these terms.

In the disclosure, the above-described description has been made mainly of specific embodiments, but the disclosure is not limited to such specific embodiments, but should rather be appreciated as covering all various modifications, equivalents, and/or substitutes of various embodiments.

1. A cooktop, comprising:
a cooktop body; and
a white ceramic glass on an upper portion of the cooktop body, the white ceramic glass including:
a plurality of micro recesses with an average depth of the plurality of micro recesses being 30 μm or less, and
a plurality of embossed portions with an average width of the plurality of embossed portions being 80 μm to 130 μm,
wherein each embossed portion of the plurality of embossed portions protrudes upward between two or more micro recesses of the plurality of micro recesses.

2. The cooktop of claim 1, wherein a surface roughness of the white ceramic glass is 1.5 μm to 2.5 μm.

3. The cooktop of claim 1, wherein an average width of the plurality of micro recesses is 100 μm or more.

4. The cooktop of claim 1, wherein an upper surface of the white ceramic glass is coated 100 μm with a coating material.

5. The cooktop of claim 1, wherein the white ceramic glass includes a beta-spodumene crystal structure.

6. The cooktop of claim 1, wherein a diameter of a crystal of the white ceramic glass is 0.9 μm to 1.1 μm.

7. The cooktop of claim 1, wherein the plurality of micro recesses are in a surface of the white ceramic glass, the surface being an elastomer particle blasted, etched, and polished surface.

8. The cooktop of claim 7, wherein
the white ceramic glass is a chemically reinforced white ceramic glass.

9. The cooktop of claim 8, further comprising:
a display device,
wherein the white ceramic glass includes a through hole corresponding to the display device so that the display device displays information through the through hole.

10. The cooktop of claim 9, wherein the white ceramic glass includes an edge reinforcement area along an edge of the through hole, the edge reinforcement area having a depth of 100 μm or less from a surface of the edge.

11. The cooktop of claim 7, wherein the elastomer particle includes a silicon elastomer coated on at least one of aluminum oxide (Al₂O₃), silicon carbide (SiC), cerium oxide (CeO₂), silicon dioxide (SiO₂), chromium dioxide (CrO₂), lanthanum oxide (La₂O₃), boron carbide (B₄C), or zirconium oxide (ZrO₂).

12. The cooktop of claim 1, wherein the white ceramic glass includes a chemically reinforced area having a depth of 100 μm or less from a surface of the white ceramic glass.

13. A method for manufacturing a white ceramic glass, the method comprising:
blasting elastomer particles onto a surface of the white ceramic glass to form a blasted surface of the white ceramic glass;
exposing the blasted surface to a hydrofluoric acid (HF) solution to form an etched surface of the white ceramic glass; and
polishing the etched surface to form a polished surface until the polished surface includes:
a plurality of micro recesses with an average depth of the plurality of micro recesses being 30 μm or less,
a plurality of embossed portions with an average width of the plurality of embossed portions being 80 μm to 130 μm,
each embossed portion of the plurality of embossed portions protrudes upward between two or more micro recesses of the plurality of micro recesses, and
a surface roughness of the polished surface is 1.5 μm to 2.5 μm.

14. The method of claim 13, further comprising:
before the blasting, perforating an area of the white ceramic glass.

15. The method of claim 14, further comprising:
chemically reinforcing the polished surface of white ceramic glass.

16. A white ceramic glass, comprising:
an upper surface including:
a plurality of micro recesses with an average depth of the plurality of micro recesses being 30 μm or less; and
a plurality of embossed portions with an average width of the plurality of embossed portions being 80 μm to 130 μm,
wherein each embossed portion of the plurality of embossed portions protrudes upward from the upper surface between two or more micro recesses of the plurality of micro recesses, and
a surface roughness of the upper surface is 1.5 μm to 2.5 μm.

17. The white ceramic glass of claim 16, wherein
a crystal structure of the white ceramic glass includes a beta-spodumene crystal structure, and
a diameter of a crystal in the crystal structure is 0.9 μm to 1.1 μm.

18. The white ceramic glass of claim 16, further comprising:
a through hole through the white ceramic glass; and
an edge reinforcement area along an edge of the through hole, the edge reinforcement area having a depth of 100 μm or less from a surface of the edge.

19. The white ceramic glass of claim 16, further comprising:
a chemically reinforced area having a depth of 100 μm or less from a surface of the white ceramic glass.

20. The white ceramic glass of claim 16, wherein the plurality of micro recesses are in a surface of the white ceramic glass, the surface being an elastomer particle blasted, etched, and polished surface.
